(19) United States
(12) Patent Application Publication
(10) Pub. No.: US 2020/0182427 A1
(43) Pub. Date: Jun. 11, 2020

(54) OPTICAL MODULE FOR A MOTOR VEHICLE

(71) Applicant: Valeo North America, Inc., Troy, MI (US)

(72) Inventors: Charles CRESPIN, Seymour, IN (US); Lionel Floc'h, Seymour, IN (US); Sylvain Giraud, Ecouflant (FR)

(73) Assignee: Valeo North America, Inc., Troy, MI (US)

(21) Appl. No.: 16/211,610

(22) Filed: Dec. 6, 2018

(51) Int. Cl. F21S 41/24; F21S 43/235; F21S 41/141; F21S 43/14

(52) U.S. Cl. CPC F21S 41/24; F21S 43/14; F21S 41/141; F21S 43/235

(57) ABSTRACT

The present invention relates to an optical module for a motor vehicle. The optical module comprises an optical element that is optically unitary; a plurality of spaced apart entry ports disposed on the optical element adapted to receive a plurality of light beams; and a plurality of optical paths within the optical element for communicating the plurality of light beams from the respective entry faces along an optical axis to an outlet portion disposed at one end of the optical element. The outlet portion comprises a plurality of deflecting facets adapted to spread the plurality of light beams and provide a unitary light output from the optical module.

### BACKGROUND OF THE INVENTION

### Field of the Invention

The present invention relates to the field of lighting and/or signalling, especially for a motor vehicle with a transparent optical module adapted to transmit a plurality of light beams. More particularly, the present invention relates to a transparent optical module adapted to transmit a plurality of light beams with a unitary light output.

### Description of the Related Art

It is well known to use a light guide for achieving a lighting and/or signalling function of an automobile vehicle. The light guide is a transparent or translucent part within which light rays propagate in a controlled manner from one end of the guide, called entry face, to the other end, called exit face. The spread in a controlled manner is generally carried out by internal reflections on various sides, called internal reflection faces.

Specifically, at least one light source is arranged close to the entry face. For example, the light source may be a light emitting diode (LED) or similar device. The rays emitted by the light sources may be subjected to collimation at the entry face to transport the light rays without internal reflections. The image of the beam produced, visible from outside, substantially corresponding to an illumination of the exit face. In some configurations, it may be desirable to extend the illuminated exit face or produce multiple beams from a single exit face.

Known optical modules to produce multiple beams from a single exit face are described in European Patent Application No. EP3179157A1. The optical module 100 described in the EP 3179157A1 includes a first light guide 105 superimposed on a second light guide 110, and both the light guides include an entry faces 115, 120 and exit faces 125, 130, as shown in FIG. 1. The first light guide 105 transmits the light produced by a first light source, for example, amber LED, from its entry face 115 to its exit face 125, and the second light guide 110 transmits the light produced by a second light source, for example, white LED, from its entry face 120 to its exit face 130. The first light source and the first light guide 110 are arranged to produce a first lighting or signalling function, and the second light source and the second light guide 110 are arranged to produce a second lighting or signalling function.

The optical module further comprises an optical mixture 135 arranged at the exit faces of both the light guides and adapted to spread the multiple beams from the first light source and the second light source on a single illuminated area, as shown in FIG. 2. FIG. 2 shows a schematic sectional view of the optical mixture 135 of the optical module 100 shown in FIG. 1, which spreads the multiple beams on a single illuminate area, in accordance with a prior-art.

Although the first light guide and the second light guide are superimposed on each other, the first light guide and the second light guide cannot touch each other due to mechanical reasons. Therefore, this type of arrangement results in creating a gap between the two light guides, which results in forming a dark line or dark area 140 in the middle of the illuminated area. Such dark lines or the dark area 140 formed on the illuminated area are highly undesirable and also may fail to meet the regulation requirements.

Accordingly, it is desirable to design an optical module so as to avoid forming of dark lines or dark areas on the illuminated area.

### SUMMARY OF THE INVENTION

Accordingly, an object of the present invention is to provide an optical module that is optically unitary and adapted to spread a plurality of light beams and is capable of providing a unitary light output from the optical module, without forming any dark areas or dark gaps on an illuminated area.

Another object of the present invention is to provide an optical module that is adapted to perform multiple lighting/signalling functions of a motor vehicle.

Yet, another object of the present invention is to obtain an optical module that is formed as optically unitary by integrating a plurality of light guides and an optical mixture as a single component using a double shot injection technique such that no gap is formed between the light guides and the optical mixer. In one embodiment, the plurality of light guides is same type of light guides. In another embodiment, the plurality of light guides is different types of light guides.

These and/or other objects may be provided by embodiments of the invention disclosed herein.

To achieve at least the above mentioned objects, there is provided an optical module used in an automotive headlamp, in accordance with an embodiment of the present invention. The optical module comprises: an optical element that is optically unitary; a plurality of spaced apart entry ports disposed on the optical element adapted to receive a plurality of light beams; and a plurality of optical paths within the optical element for communicating the plurality of light beams from the respective entry faces along the optical axis to an outlet portion disposed at one end of the optical element. The outlet portion comprises a plurality of deflecting facets adapted to spread the plurality of light beams and provide a unitary light output from the optical module.

In an aspect, the at least one of the plurality of spaced apart entry ports comprise a collimator to collimate at least one of the plurality of light beams.

In an embodiment, the optical element is comprised of a single polymeric piece. In another embodiment, the optical element, the outlet portion, and the collimator are comprised of a single polymeric piece. Yet, in another embodiment, the optical element and the outlet portion are comprised of a single polymeric piece. Still in another embodiment, the optical element, the plurality of spaced apart entry ports, the collimator, and the outlet portion are comprised of a single polymeric piece.

In one embodiment, the plurality of deflecting facets on the outlet portion comprises: a plurality of first deflecting facets inclined relative to the optical axis and adapted to reflect the light beams transversely to the optical axis; a plurality of second deflecting facets positioned transversely to the first deflecting facets, so as to reflect the collimated light beams from the first deflecting facets to the illuminated area of the optical module; a plurality of transverse facets; and a plurality of longitudinal facets extending substantially along the optical axis.

In an embodiment, both an upper face and a lower face of the outlet portion comprises: at least one first deflecting facet; at least one second deflecting facet; at least one transverse facet; and at least one longitudinal facet. In an aspect, the upper face is formed by sequentially arranging a second deflecting facet, a longitudinal facet, a transverse facet, and a first deflecting facet. Further, the lower face is formed by sequentially arranging a first deflecting facet, a longitudinal facet, a second deflecting facet, and a transverse facet.

In an embodiment, the plurality of spaced apart entry ports are disposed on a same outer side of the optical module. In another embodiment, the plurality of spaced apart entry ports are disposed on an opposing or adjacent outer side of the optical module.

In accordance with a preferred embodiment of the present invention, the optical module comprises an optical element that is optically unitary having a plurality of spaced apart entry ports to receive a plurality of light beams and a collimator to collimate the plurality of light beams, and a plurality of optical paths within the optical element for communicating the plurality of light beams from the respective entry faces along the optical axis to an outlet portion. The outlet portion comprises a plurality of deflecting facets adapted to spread the plurality of light beams and provide a unitary light output from the optical module, further wherein the optical element, the plurality of spaced apart entry ports, the collimator and the outlet portion are comprised of a single polymeric piece.

These and other objects and advantages of the invention will be apparent from the following description, the accompanying drawings and the appended claims.

### BRIEF DESCRIPTION OF THE DRAWINGS

FIG. 1 shows a perspective view of an optical module, in accordance with a prior-art.

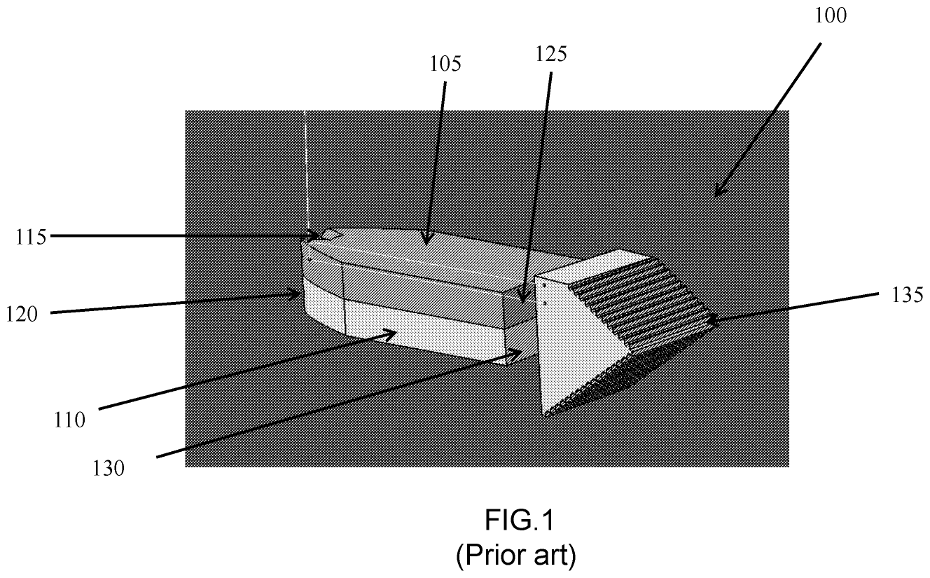

FIG. 2 shows a schematic sectional view of an optical mixture of the optical module shown in FIG. 1, which spreads the multiple light beams on a single illuminate area, in accordance with a prior-art.

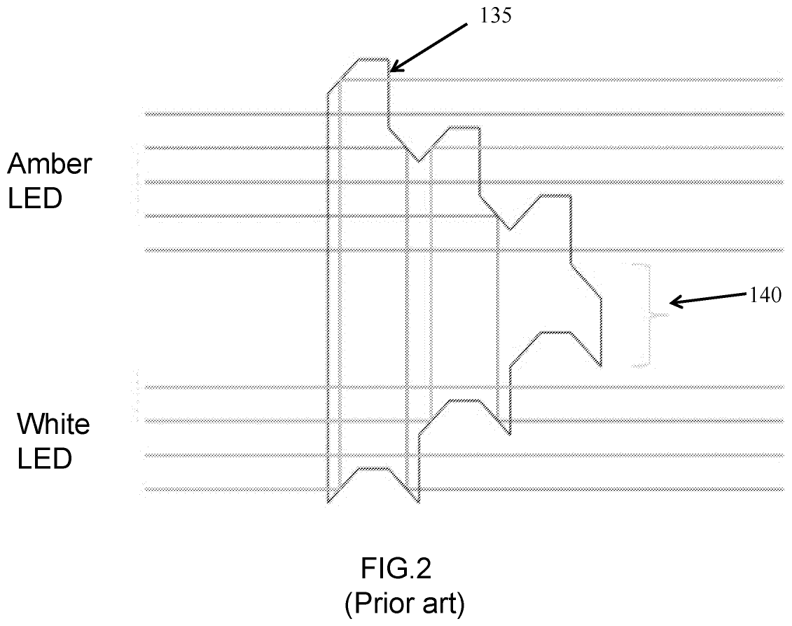

FIG. 3 shows a perspective view of an optical module that is optically unitary, in accordance with an embodiment of the present invention.

FIG. 4 shows a side view of the optical module shown in FIG. 3, in accordance with an embodiment of the present invention.

FIG. 5 shows a side view of an outlet portion of the optical module shown in FIG. 3, in accordance with an embodiment of the present invention.

### DETAILED DESCRIPTION OF THE DRAWINGS

The embodiments of the present invention will be further explained below with reference to the figures and examples. Throughout the description, the same or similar reference numbers indicate the same or similar members. The following embodiments along with the figures are only used to explain the general concept of the present invention, instead of being intended to limit the scope of the present invention.

The present invention relates to an optical module that is optically unitary and adapted to spread a plurality of light beams and is capable of providing a unitary light output from the optical module, without forming any dark areas or dark gaps on an illuminated area. The optical module functions for providing lighting, signalling, or both for a motor vehicle.

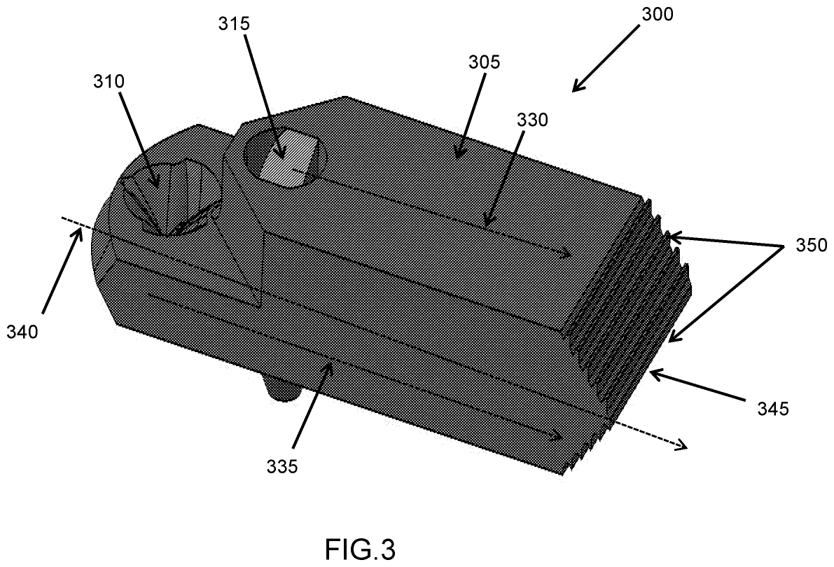

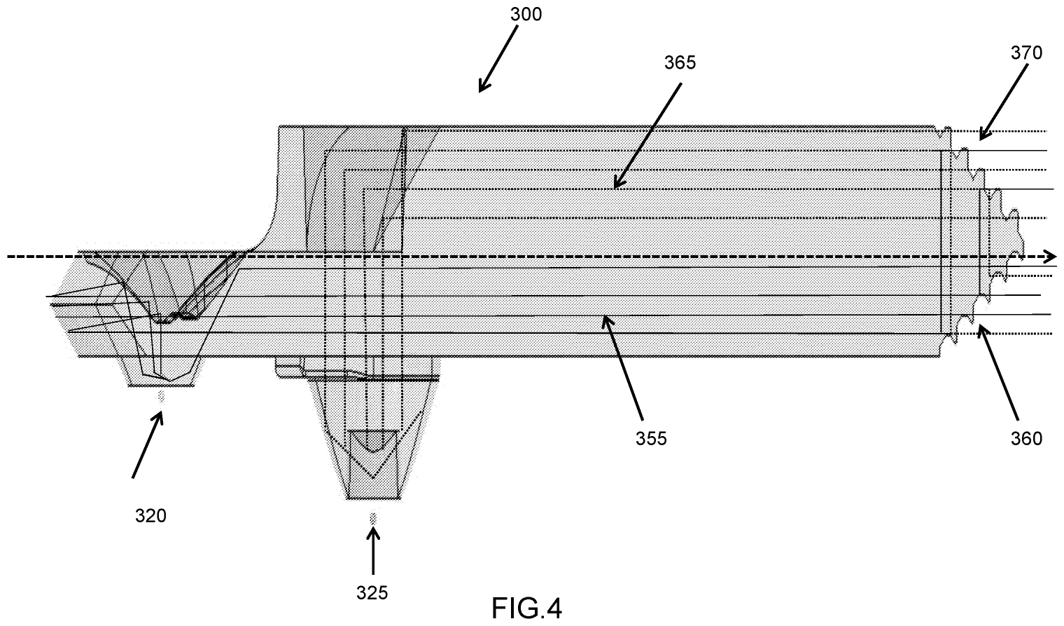

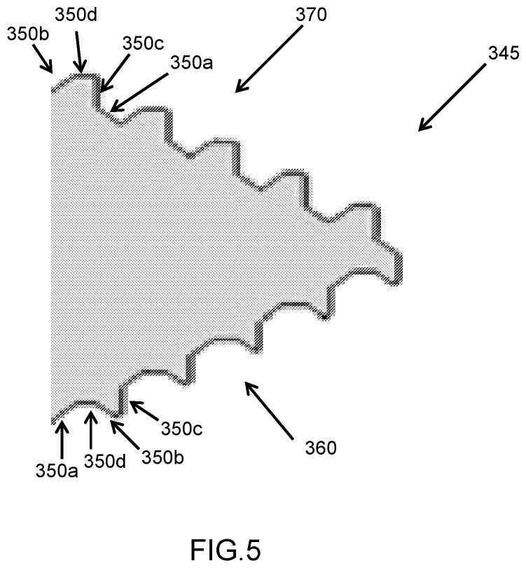

FIG. 3 shows a perspective view of an optical module 300 for a motor vehicle, in accordance with an embodiment of the present invention. FIG. 4 shows a side view of the optical module 300 shown in FIG. 3, in accordance with an embodiment of the present invention. FIG. 5 shows a side view of an outlet portion of the optical module 300 shown in FIG. 3, in accordance with an embodiment of the present invention.

As can be seen from FIG. 3, the optical module 300 comprises an optical element 305 is optically unitary. In an aspect, the optical module 300 is made from a transparent or translucent material, such as polycarbonate (PC) or glass.

In one embodiment, the optical module 300 comprises a plurality of spaced apart entry ports 310,315 disposed on the optical element 305 adapted to receive a plurality of light beams. The plurality of light beams is for performing a plurality of functions (lighting and/or signalling) of the motor vehicle. The plurality of light beams may be produced from the plurality of light sources 320, 325 (shown in the FIG. 4), for example, Light Emitting Diodes (LEDs). For example, the light sources 320, 325 include a white LED and an amber LED for performing a first function and a second function, respectively. In an aspect, one or more light sources are disposed at each entry port of the optical module 300.

In one embodiment, the plurality of spaced apart entry ports 310,315 are disposed on a same outer side of the optical module 300. In another embodiment, the plurality of spaced apart entry ports 310, 315 are disposed on an opposing or adjacent outer side of the optical module 300. Further, the plurality of spaced apart entry faces 310, 315 comprise a collimator (not shown in the Figures) to collimate at least one of the pluralities of light beams emitted from the plurality of light sources 320,325.

The optical module 300 further comprises a plurality of optical paths 330, 335 within the optical element 305 for communicating the plurality of light beams from the respective entry ports 310,315 along the optical axis 340 to an outlet portion 345 disposed at one end of the optical element 305. The outlet portion 345 comprises a plurality of deflecting facets 350 adapted to spread the plurality of light beams and provide a unitary light output from the optical module 300. The construction of the outlet portion 345 is explained in detail with respect to FIG. 5.

As can be seen from FIG. 3 and FIG. 4, two light beams from the respective entry ports 310, 315 are communicated to the outlet portion 345 using two optical paths 330,335. For the purpose of explanation, the optical module 300 with two entry ports 310,315 and the two optical paths 330,335 is shown in FIG. 3 and FIG. 4. However, it is understood to a person skilled in the art that the present invention can be implemented with the plurality of light sources and plurality of optical paths, without any limitation.

In one embodiment, the optical element 305 is formed by integrating two different types of light guides such that two optical paths 330,335 are formed to guide the light beams from the entry ports to the outlet portion. For example, two different light guides include a collimated light guide and a hybrid light guide. The person skilled in the art is well known about the collimated light guide and the hybrid light guide, and therefore the details of the above mentioned light guides are not discussed in this description.

In another embodiment, the optical element 305 is formed by integrating two similar light guides such that the two optical paths 330,335 are formed to guide the light beams from the entry ports to the outlet portion. In an example, two light guides are collimated light guides. In another example, two light guides are hybrid light guides.

In order to avoid forming dark area or dark gap on the illuminated area, the optical module 300 of the present invention is designed in such a way that the optical element 305 and the outlet portion 345 are comprised of a single polymeric piece. In another embodiment, the optical element 305, the collimator, and the outlet portion 345 are comprised of a single polymeric piece. Yet, in another embodiment, the optical element 305, the plurality of spaced apart entry ports 310,315, the collimator, and the outlet portion 345 are comprised of a single polymeric piece.

For example, in the present invention, a double shot injection technique is employed to form the optical module 300 as a single polymeric piece. This double shot injection technique is well known to a person skilled in the art and hence this technique is not explained in detail in this description. Further, it is understood to a person skilled in the art that any suitable injection technique may be employed to form the optical module 300 of the present invention as a single polymeric piece.

Operation of the optical module 300 is explained in detail by referring to the FIG. 3, FIG. 4 and FIG. 5. As can be seen from FIG. 3 and FIG. 4, a first light beam 355 (shown in solid lines in the FIG. 4) emitted from a first light source 320 is communicated to the outlet portion 345 via a first optical path along the optical axis 340 to the lower surface 360 of the outlet portion 345. Likewise, a second light beam 365 (shown in dotted lines in the FIG. 4) emitted from a second light source 325 is communicated to the upper surface 370 of the outlet portion 345. The plurality of deflecting facets 350 on the outlet portion 345 is arranged in a way such that the light beams are spread across the entire outlet portion 345, as shown in FIG. 4.

Further, even if the outlet portion 345 is illuminated by a single light beam, still the entire outlet portion 345 is illuminated because of the arrangement of the deflecting facets on the outlet portion 345. For example, some of the rays of the first light beam 355 emitted by the first light source 320 are partially reflected upwardly by some of the deflecting facets of the lower surface 360 of the outlet portion 345. These rays are then spread on the outlet portion 345 at the upper surface 370. The remaining rays of the first light beam 355 are directly spread on the lower portion 360 of the outlet portion 345, without any reflections. The entire outlet portion 345 is thus illuminated.

FIG. 5 shows a side view of an outlet portion of the optical module shown in FIG. 3, in accordance with an embodiment of the present invention. As previously mentioned, the outlet portion 345 comprises a plurality of deflecting facets 350 adapted to spread the plurality of light beams and provide a unitary light output from the optical module 300. As can be seen from the FIG. 5, the profile of the outlet portion 345 is V-shaped and comprises the upper surface 360 and the lower surface 370.

The plurality of deflecting facets 350 on the outlet portion 345 comprises: a plurality of first deflecting facets 350a inclined relative to the optical axis 340 and adapted to reflect the light beams transversely to the optical axis 340; and a plurality of second deflecting facets 350b positioned transversely to the first deflecting facets, so as to reflect the rays of the light beams from the first deflecting facets 350a to the illuminated area of the optical module 300. The outlet portion 346 further comprises a plurality of transverse facets 350c to the optical axis 340 and adapted to transmit light beams coming directly from the second deflecting facets 350b; and a plurality of longitudinal facets 350d extending substantially along the optical axis 340.

Both the upper face 370 and the bottom face 360 of the outlet portion 345 comprises: at least one first deflecting facet 350a; at least one second deflecting facet 350b; at least one transverse facet 350c; and at least one longitudinal facet 350d.

In one embodiment, the upper face 370 is formed by sequentially arranging a second deflecting facet 350b, a longitudinal facet 350c, a transverse facet 350d, and a first deflecting facet 350a. Further, the lower face 360 is formed by sequentially arranging a first deflecting facet 350b, a longitudinal facet 350c, a second deflecting facet 350b, and a transverse facet 350d.

In operation, some of the rays of the first light beam 355 emitted by the first light source 320 are reflected by the first deflecting facets 350a to meet the second deflecting facets 350b. The rays reflected by the first deflecting facets 350b are oriented substantially perpendicular to the optical axis to meet the second deflecting facets 350b. These rays are then get out of the optical module 300 through the transverse facets 350c at the upper face 370 of the outlet portion 345 substantially parallel to the optical axis. The rest of the rays of the first light beam 355, that is to say, the rays not reflected by the first deflecting facets 350a encounter transverse facets 350c on the lower face 360 of the outlet portion 345, without undergoing substantial deviation. Similarly, some of the rays of the second light beam 365 undergo reflections and then out of the outlet portion 345, and remaining rays of the second light beam 365 are directly out of the outlet portion 345, without undergoing substantial deviation. Consequently, the light beams 355, 365 are spread to provide the unitary light output from the optical module 300, without forming any dark area or dark lines on the illuminated area.

Although the present disclosure is provided with reference to figures, all of the embodiments shown in figures are intended to explain the preferred embodiments of the present invention by way of example, instead of being intended to limit the present invention.

Apparently, it would be appreciated by those skilled in the art that various changes or modifications may be made in the present disclosure without departing from the principles and spirit of the disclosure, which are intended to be covered by the present invention as long as these changes or modifications fall within the scope defined in the claims and their equivalents.

The disclosures of all articles and references, including patent applications and publications are incorporated by reference for all purposes.

The term “consisting essentially” of to describe a combination shall include the elements, ingredients, components or steps identified, and such other elements ingredients, components or steps that do not materially affect the basic and novel characteristics of the combination.

The use of the terms “comprising” or “including” to describe combinations of elements, ingredients, components or steps herein also contemplates embodiments that consist essentially of the elements, ingredients, components or steps.

1. An optical module of a motor vehicle comprising:
an optical element having a unitary body including a top surface and a bottom surface and being configured to provide uniform light output across a dimension defined between the top surface and the bottom surface;
a plurality of entry ports disposed on a first end of the optical element and arranged orthogonal to an optical axis of the optical module, the plurality of entry ports being spaced apart along the optical axis of the optical module and adapted to receive a plurality of light beams directly from respective light sources; and
a plurality of optical paths within the optical element for communicating the plurality of light beams from respective entry ports along the optical axis of the optical module to an outlet portion disposed at a second end of the optical element opposite the first end of the optical element,
wherein the outlet portion comprises a plurality of deflecting facets adapted to spread the plurality of light beams and provide the uniform light output across the dimension defined between the top surface and the bottom surface.

2. The optical module of claim 1, wherein at least one of the plurality of entry ports comprise a collimator to collimate at least one of the plurality of light beams.

3. The optical module of claim 1, wherein the optical element is comprised of a single polymeric piece.

4. The optical module of claim 2, wherein the optical element, the outlet portion and the collimator are comprised of a single polymeric piece.

5. The optical module of claim 1, wherein the optical element and the outlet portion are comprised of a single polymeric piece.

6. The optical module of claim 2, wherein the optical element, the plurality of entry ports, the collimator, and the outlet portion are comprised of a single polymeric piece.

7. The optical module of claim 1, wherein the plurality of deflecting facets comprises
a plurality of first deflecting facets inclined relative to the optical axis of the optical module and adapted to reflect collimated light beams transversely to the optical axis of the optical module,
a plurality of second deflecting facets positioned transversely to the plurality of first deflecting facets, so as to reflect the collimated light beams from the plurality of first deflecting facets to an illuminated area of the optical module,
a plurality of transverse facets to the optical axis of the optical module adapted to transmit the collimated light beams coming directly from the optical element or the collimated light beams reflected from the plurality of second deflecting facets, and
a plurality of longitudinal facets extending substantially along the optical axis of the optical module.

8. The optical module of claim 7, wherein the outlet portion comprises an upper face and a bottom face, each comprising
at least one first deflecting facet,
at least one second deflecting facet,
at least one transverse facet, and
at least one longitudinal facet.

9. The optical module of claim 8, wherein the upper face is formed by sequentially arranging thereon singular ones of the at least one second deflecting facet, the at least one longitudinal facet, the at least one transverse facet, and the at least one first deflecting facet.

10. The optical module of claim 8, wherein the bottom face is formed by sequentially arranging thereon singular ones of the at least one first deflecting facet, the at least one longitudinal facet, the at least one second deflecting facet, and the at least one transverse facet.

11. The optical module of claim 1, wherein the plurality of entry ports are disposed on a same outer side of the optical module.

12. The optical module of claim 1, wherein the plurality of entry ports are disposed on an opposing or adjacent outer side of the optical module.

13. The optical module of claim 1, wherein the optical module functions for providing lighting, signalling, or both for the motor vehicle.

14. An optical module of a motor vehicle comprising:
an optical element including
a unitary body including a top surface and a bottom surface and being configured to provide uniform light output across a dimension defined between the top surface and the bottom surface,
a plurality of entry ports disposed on a first end of the optical element and arranged orthogonal to an optical axis of the optical module, the plurality of entry ports being spaced apparat along the optical axis of the optical module and being configured to receive a plurality of light beams directly from respective light sources, and
a collimator to collimate the plurality of light beams, and a plurality of optical paths within the optical element for communicating the plurality of light beams from respective entry ports along the optical axis of the optical module to an outlet portion disposed at a second end of the optical element opposite the first end of the optical element, wherein
the outlet portion comprises a plurality of deflecting facets adapted to spread the plurality of light beams and provide the uniform light output across the dimension defined between the top surface and the bottom surface, and
the optical element, the plurality of entry ports, the collimator, and the outlet portion are comprised of a single polymeric piece.
